(19) United States
(12) Patent Application Publication
(10) Pub. No.: US 2024/0410806 A1
(43) Pub. Date: Dec. 12, 2024

(54) Method and Apparatus for Determining the Equivalent Diameter of Powder Particles

(71) Applicant: H.C. Starck Tungsten GmbH, Goslar (DE)

(72) Inventors: Tino Saeuberlich, Bad Säckingen (DE); Alexander Zeugner, Goslar (DE); Juliane Meese-Marktscheffel, Goslar (DE)

(21) Appl. No.: 18/717,003

(22) PCT Filed: Dec. 7, 2022
(86) PCT No.: PCT/EP2022/084834

§ 371 Date: Jun. 6, 2024

(30) Foreign Application Priority Data
Dec. 15, 2021 (EP) 21214613.8

(51) Int. Cl. G01N 15/02; G01F 1/34; G01N 15/08

(52) U.S. Cl. CPC G01N 15/0255; G01F 1/34; G01N 15/088

(57) ABSTRACT

The present invention relates to a process for determining the equivalent diameter of particles of a powder, and a device for performing such process.

The present invention relates to a process for determining the equivalent diameter of particles of a powder, and a device for performing such process.

The grain size describes the size of individual particles in a mixture and is an essential parameter for characterizing inorganic powders, as employed, for example, in metallurgy or the cement industry. There, the grain size serves as a material-specific characteristic by which different powder qualities can be distinguished easily, precisely and reproducibly.

The determination of the grain size usually refers to the equivalent diameter, which takes account of the fact that the grains are not in the form of perfect spheres. The equivalent diameter can be illustrated by using the sieve diameter. Both a sphere with a diameter of, for example, 1 mm and an elongate grain with a diameter of 1 mm fit through a square hole of a sieve with an edge length of 1 mm. For example, even a rounded flat grain with a diameter of more than 1 mm would fit through when considering the diagonal of the hole. Although the grains are different in terms of their shape, an equivalent diameter of 1 mm is stated for them all. In general, the equivalent diameter is based on the diameter of spheres of the same volume. Especially for materials with a constant density and approximately spherical shape, the properties of theoretically derivable sphere packings, in which all the spheres have the same size, may be employed. If then a property of a real system is measured, for example, the fluid-mechanical properties, the values obtained can be assigned in accordance with the theoretical system.

From today's perspective, a number of methods are available by which the equivalent diameter can be determined as a measure of the grain size of solid, non-porous particles. In addition to laser diffraction, for example, sieve analyses, sedimentation analyses or the determination of surface area by the BET method are known. Mainly in the field of carbide industry, the FSSS method (Fisher Sub Sieve Sizer) has been wide-spread for decades, representing the basics for the classification and comparison of different hard materials and metal powders, such as tungsten carbide, in which a relatively narrow monomodal particle size distribution is an important precondition to the application of such methods.

The FSSS method, which is widespread on an industrial scale, stems from the 1940's and is based on the gas permeability of compressed powder samples. A mean grain size, which corresponds to the equivalent diameter of a sphere of the same volume, can be determined by this method. The measuring method and the corresponding commercially available devices are described in some detail in the standard ASTM B330-Standard Test Methods for Estimating Average Particle Size of Metal Powders and Related Compounds Using Air Permeability. For determining the equivalent diameter, a gas flow is passed through a defined powder pellet, and the pressure difference is measured (see FIG. 5a). Using the Carman-Kozeny equation (1), the equivalent diameter (D) can be derived from the ratio of pressure loss and gas flow rate.

$$\frac{Δ p}{L} = ∘ \frac{180 \cdot μ}{{ϕ}^{2} \cdot {D}^{2}} ∘ \cdot \frac{{( 1 - ε )}^{2}}{{ε}^{3}} ∘ \cdot \frac{Q}{A} y \to ( 1 ) , \cdot ¶$$

with Δp: pressure difference [Pa]; L: length of the test specimen flowed through [m]; μ: dynamic viscosity of the measuring gas [Pa*s]; ϕ: form factor (usually set to 1); ε: porosity [-], A: cross-sectional area of the specimen perpendicular to the direction of flow [m²], Q: volume flow [m³/s], D: equivalent diameter of the sphere having the same volume [m],

From the following equations (2) and (3), in which m is the mass of the specimen [kg]; p is the physical density of the material to be measured [kg/m³]; and L is the length of the specimen flowed through [m],

$$K = \frac{180 \cdot μ}{{ϕ}^{2}} \cdot \frac{{( 1 - ε )}^{2}}{{ε}^{3}} \qquad ( 2 )$$

$$ε = 1 - \frac{m}{ρ \cdot L \cdot A} \qquad ( 3 )$$

the following relationship results:

$$D = \sqrt{\frac{K \cdot L}{A} \cdot \frac{Q}{Δ p}} \qquad ( 4 )$$

for calculating the equivalent diameter.

The general physical relationships between permeability and gas diffusion are summarized in Terence Allen: Chapter 1: “Permeability and gas diffusion”, Jan. 1, 1997, PARTICLE SIZE MEASUREMENT—Vol. 2: SURFACE AREA AND PORE SIZE DETERMINATION, CHAPMAN & HALL, GB, pages 1-38.

In their article “Pressure drop characteristics of poly (high internal phase emulsion) monoliths”, published in Journal of Chromatography A, 1144 (2007) 48-54, I. Junkar et al. deal with the influence of porosity on the pressure loss in liquid chromatography, the focus being on models for calculating porosity.

In “Packing density, permeability, and separation efficiency of packed microchips at different particle-aspect ratios”, Journal of Chromatography A, 1216 (2009) 264-273, S. Jung et al. examine HPLC microchips in terms of their packing density, the relationship between pressure drop and flow rate, the hydraulic permeability, and their separation efficiency.

GB 2 025 069 deals with the problem of sample provision, and proposes, in particular, a process for preparing a pressed powder pellet.

JP 3125263 describes a method for preparing a semiconductor ceramics, in which the particle size of the ceramic particles is determined using the Carman-Kozeny equation, and controlled by adding an agent for controlling the particle size.

JP 5033678 discloses a process and a device for determining the particle size based on the Carman-Kozeny equation.

The methods described in the prior art, which are marked by the Carman-Kozeny equation, by which the pressure loss of a powder packing flowed through can be calculated in general, have the drawback that the equation applies only to steady states, which means that there is no change of the volume flow rate or pressure in time. The available measuring set-ups are not capable technically of selectively varying the pressure or volume flow rate.

The term Q/Δp of the Carman-Kozeny equation can be referred to as the conductance L_{R} of the bulk. The conductance L_{R} in [m³/(s*Pa)] represents a characteristic quantity, which depends on the structure of the particle system to be examined, and may be compared in mind with Ohm's law R=U/I, in which the electric conductance of a resistor is described by 1/R=I/U. According to the Carman-Kozeny equation, the conductance L_{R} can be determined by measuring the pressure drop Δp at a defined flow rate, i.e., at a defined constant volume flow rate Q. However, it is mandatory here that all the quantities are in a steady state, not subject to a change in time. When using the conductance, the Carman-Kozeny equation will change into the following form:

$$D = \sqrt{\frac{K \cdot L}{A} \cdot {L}_{R}}$$

This method of determining the particle size allows for a coarse estimation of particle size. For determining more exact values for L_{R}, the measurement must be repeated at different volume flow rates. However, for each measurement, one has to wait until a steady state is obtained in the measuring system, so that this type of measuring is time-consuming and thus expensive. Thus, in this type of measuring, a disadvantageous discrepancy results between the time necessary for one measurement, and the precision that can be achieved.

The measuring systems established in the field of carbide industry, especially including those according to the FSSS process, have some other disadvantages in addition to the discrepancy mentioned above. Thus, one parameter employed for determining the equivalent diameter is the porosity of the specimen, which is usually obtained from the height of a compressed cylindrical specimen using a nomogram on the measuring device by a visual judgment, with the corresponding inaccuracy, which results in random errors, which contribute to a broad measuring spread. As another drawback, the measuring method of the FSSS process schedules only a one-point measurement, which may result in further errors. In addition, the current issue of the relevant standard ASTM B330 points out that the FSSS method will no longer be a standard-like method in the future, the lack of availability of devices and spare parts and the lack of technical support being stated as the reasons.

Before this background, the object of the present invention is to provide a measuring process and a corresponding device for determining the equivalent diameter of powder particles. The provided process is supposed to achieve an improved precision of the measured values and thus a reduction of the measurement spread, without extending the time needed for one measurement.

To achieve this object, the present invention follows the approach of providing a process by which the conductance L_{R} can be determined without having to wait for a steady state in each measurement. According to the present invention, this is achieved by the fact that a constant volume flow rate Q is no longer used, but a volume flow rate that increases with time Q=Q(t) is used. Under the condition of a dynamic volume flow, the linear relationship between Q and Δp, on which the conventional measuring methods are based, is removed. Rather, the determination of the relationship between Q and Δp according to the process according to the invention is effected from a non-linear characteristic by multivariate regression, rather than by simple calculation of quotients.

Surprisingly, it has been found that this kind of determination yields a more precise measurement that is associated with less measuring spread in a short measuring time.

Therefore, the present invention firstly relates to a process for determining the equivalent diameter D of powder particles, wherein said equivalent diameter is determined by recording a non-linear characteristic from Q(t) versus Δp(t), in which Q(t) refers to the volume flow rate as a function of time, and Δp(t) refers to the pressure difference as a function of time. In particular, the characteristic is obtained by plotting time-equivalent pairs of values of Δp(t) versus Q(t), in which Q(t) is preferably plotted on the x axis, and Δp(t) is preferably plotted on the y axis.

Within the scope of the present invention, Q designates the volume flow rate of a measuring gas that flows through a compressed powder specimen.

Q(t) refers to the volume flow rate as a function of time.

Δp designates the pressure change occurring in the direction of flow when a measuring gas flows through a compressed powder sample, and can be calculated from the difference between the pressure pᵤₚ upstream of the compressed powder sample, and the pressure p_{down} downstream of the compressed powder sample.

Δp(t) refers to the pressure difference as a function of time.

The recording of the non-linear characteristic, which according to the inventive process underlies the determination of the equivalent diameter, can be achieved either by adjusting a volume flow rate Q(t) of the measuring gas that increases with time, or by means of a pressure difference Δp(t) that changes with time.

Therefore, in a preferred embodiment of the process according to the invention, the characteristic describes a non-linear relationship between the pressure difference Δp(t) and the volume flow rate Q(t),
in which Δp(t) designates the difference, occurring in the direction of flow, of a measuring gas when flowing through a compressed powder sample,
in which Q(t) designates the volume flow rate, which increases constantly over time, of the measuring gas, in which:
dQ(t)/dt=q₀, with q₀=const., and q₀>0,
   where q₀ designates the volume flow change rate in [L/s²].

According to the preferred embodiment, a constantly increasing volume flow rate Q(t)=q₀*t is imposed on the system, while the pressure is continuously measured upstream and at the same time downstream of the sample flowed through. Thus, all quantities change continuously over time, so that the system is not in a steady state. Rather, the pressure and volume flow rate are time-dependent quantities, in which a constant volume flow change rate q₀ [L/s²] is preferred.

In an alternatively preferred embodiment of the process according to the invention, the non-linear characteristic describes a relationship between the pressure difference Δp(t) and the volume flow rate Q(t), wherein Δp(t) is the pressure difference in the direction of flow, which is changing over time at a constant change rate, between the pressure pᵤₚ upstream of a compressed powder sample, and the pressure p_{down} downstream of the compressed powder sample, in which:

dΔp(t)/dt=p₀, with p₀=const. and p₀>0;

in which Q(t) refers to the volume flow rate of a measuring gas, which is constantly increasing over time, and p₀ refers to the pressure change rate in [Pa/s].

According to this preferred embodiment, the pressure difference over the compressed powder sample changes at a rate p₀ [Pa/s] that is constant in time. At the same time, the volume flow rate of the measuring gas that is required to generate the corresponding pressure difference is measured. Both quantities change continuously over time, so that the system does not reach a steady state. According to the preferred embodiment, a constant pressure change rate p₀ is preferred.

As set forth above, conventional methods for determining the particle size based on the equivalent diameter, such as the FSSS method, have the disadvantage that they operate with a constant volume flow rate, so that reliable values can be obtained only if one waits until the gas volume within the measuring device, which depends on construction, and in the specimen have filled with the measuring gas, i.e., until the incoming volume flow rate equals the outgoing volume flow rate, and the system is in a steady state. The arrival of the steady state can take several minutes, depending on the powder specimen. Not to wait until this state arrives results in an erroneous evaluation. If the system is given enough time in each measurement until the steady state has arrived, the measuring time is extended disproportionately, especially if several measurements with different volume flow rates are to be performed.

Within the scope of the process according to the invention, it has surprisingly been found that the measuring uncertainties occurring in the conventional methods can be overcome by not setting a constant volume flow rate of the measuring gas, but the volume flow rate Q or the pressure difference Δp are varied as a function of time.

Thus, the measuring method according to the invention is not based on a constant volume flow rate, but on a defined volume flow change rate. Much the same applies to a variation of pressure. In this way, the precision of the measured values could be significantly increased, but also the measuring time could be advantageously shortened as compared to conventional measuring methods.

Building on this, in a preferred embodiment, the process according to the invention comprises the following steps:
i) providing a compressed powder specimen;
ii) determining the porosity of the compressed powder specimen based on the mass and height of the compressed powder specimen;
iii) establishing the conductance L_{R} by allowing a measuring gas to flow through the compressed powder specimen and continuously varying Δp as a function of time Δp(t), or Q as a function of time Q(t), to obtain a non-linear characteristic,
in which Δp(t) designates the pressure difference occurring in the direction of flow between the pressure pᵤₚ upstream of the compressed powder sample, and the pressure p_{down} downstream of the compressed powder sample;
in which Q(t) designates the volume flow rate of the measuring gas, and L_{R}=Q/Δp; and
iv) establishing the equivalent diameter D by derivation from the non-linear characteristic Q(t) versus Δp(t), taking the porosity of the compressed powder sample established in ii) into account.

The pressure difference Δp can be determined by measuring the pressure pᵤₚ of the measuring gas before it flows through the specimen, and the pressure p_{down} of the measuring gas after it flows through the specimen.

A gas selected from the group consisting of dry air, nitrogen, argon, helium, carbon dioxide is preferably employed as the measuring gas. The measuring gas can be chosen as a function of the expected grain size, wherein it has proven advantageous to use higher viscosity measuring gases for coarser grain sizes. The stated measuring gases are characterized by not undergoing any chemical reactions with the powder specimen to be measured.

Within the scope of the process according to the invention, an improved precision of the measured values while the measuring time is shortened is achieved by including a non-linear characteristic Q(t) versus Δp(t), which is characterized in that its evaluation dispenses with a reference to the zero point. Therefore, an embodiment of the process according to the invention is preferred in which at least two different measuring points are established in step iii) that do not correspond to the zero point (Δp=0; or Q=0) of the characteristic. Preferably, at least 5 measuring points per minute, more preferably at least 12 measuring points per minute, are established within the scope of the process according to the invention.

The measured values required for recording the non-linear characteristic of the relationship between Δp and Q may be obtained by varying either parameter over time, t. In a preferred embodiment, the non-linear characteristic of the relationship between Δp and Q is established by varying the volume flow rate Q(t). In an alternatively preferred embodiment, the non-linear characteristic of the relationship between Δp and Q is established as a time course of pressure pᵤₚ(t).

In a particularly preferred embodiment, the non-linear characteristic of the relationship between Δp and Q is established as a time course of the pressure pᵤₚ(t) upstream of the powder pellet at a defined volume flow rate, Q(t), which is also a function of time, in which the volume flow rate is increased by a constant value in a particular time interval. Therefore, in a preferred embodiment, the process according to the invention comprises the following steps:
i) providing a compressed powder specimen;
ii) determining the porosity of the compressed powder specimen based on the mass and height of the compressed powder specimen;
iii) setting a constant volume flow change rate q₀ of a measuring gas for flowing through the compressed powder sample, wherein

dQ(t)/dt=q₀ with q₀=const.;
iv) establishing the conductance L_{R} from a non-linear characteristic Q(t) versus Δp(t), in which Δp(t) is the pressure difference between the pressure pᵤₚ upstream of the compressed powder sample and the pressure p_{down} downstream of the compressed powder sample as a function of time,
iv) establishing the equivalent diameter D by derivation from the non-linear characteristic, taking the porosity of the compressed powder sample established in ii) into account.

In another preferred embodiment, the non-linear characteristic of the relationship between Δp(t) and Q(t) is obtained as a time course of the pressure pᵤₚ(t) upstream of the powder pellet as the volume flow rate Q(t) rises continuously. Surprisingly, it has been found that a particularly narrow distribution of the measured values can be achieved in both cases. Therefore, an embodiment is preferred in which said process according to the invention includes the following steps:
i) providing a compressed powder sample;
ii) determining the porosity of the compressed powder specimen based on the mass and height of the compressed powder specimen;
iii) setting a volume flow rate Q(t) of a measuring gas for flowing through the compressed powder sample in such a way that the pressure difference Δp(t) between the pressure pᵤₚ upstream of the compressed powder sample and the pressure p_{down} downstream of the compressed powder sample changes at a rate p₀ that is constant in time, wherein p₀=dΔp(t)/dt;
iv) establishing the conductance L_{R} from a non-linear characteristic Q(t) versus Δp(t),
iv) establishing the equivalent diameter D by derivation from the non-linear characteristic, taking the porosity of the compressed powder sample established in ii) into account.

Within the scope of the present invention, it has surprisingly been found that as compared with conventional measuring methods, in which either a constant pressure or a constant volume flow rate is set, an improvement of the precision of the measured values is achieved by changing one of these two quantities in a defined way. Without being bound by theory, it is assumed that the improved precision is achieved because measuring errors that occur are measured along several times and then can be eliminated. In a preferred embodiment of the invention, this is done by multivariate regression.

The porosity of the compressed powder sample may be mentioned as another parameter that is included in the determination of equivalent diameter according to the invention.

A geometrically defined powder pellet can be prepared for measuring the sample. Advantageously, the shape is selected so that a cross-sectional area is produced that is constant over height and whose normal vector is parallel to the direction of the pressing force. This requirement is advantageously met by a cuboid or a cylinder, wherein cylinder-shaped geometries are given preference. Accordingly, an embodiment is preferred in which the determination of the porosity of the compressed powder sample in step ii) of the process according to the invention is effected with a cylinder-shaped powder pellet. As those skilled in the art will know, the porosity of the compressed powder sample can be determined from its mass, cross-sectional area and height (equation (3)), in which the size of the powder pellet in the direction of flow of the measuring gas is to be considered its height. In order to achieve a better handling of the powder pellet, the latter is preferably provided in a sample tube.

Within the scope of the process according to the invention, it has been found that measuring inaccuracies will occur, in particular, because of imprecise determinations of the height of the powder pellet. In order to minimize this source of errors, it has proven advantageous if the sample to be measured is respectively compressed with a defined force. Therefore, an embodiment of the process according to the invention is preferred in which the compressing of the powder sample to be measured is effected with a defined force. Preferably, a mechanical pressure of 0.5 to 3 MPa, preferably 1 to 2 MPa, is applied for compression.

In order to achieve a uniform sample preparation and exact measuring of the height of the compressed powder sample, it has proven advantageous if the sample preparation and the measuring are automated at least in part. Therefore, an embodiment is preferred in which the compression of the powder sample for preparing the compressed powder sample is effected in an automated way. In this way, a unitary and reproducible determination of porosity can be achieved.

Another difficulty in the determination of the equivalent diameter is the limited provision of suitable devices. Therefore, the present invention further relates to a device for performing the process according to the invention. The device includes a receiving means for receiving a sample tube with a compressed powder sample, a data acquisition means for acquiring the data pᵤₚ(t) and p_{down}(t), or Δp(t), and Q(t), a data processing unit, a data output means, a process computer, at least one pressure control means, an inlet means and an outlet means for a measuring gas, and at least one controller for feedback controlling the volume flow rate of the measuring gas.

Preferably, the pressure control means and the regulator for feedback controlling the volume flow rate are electronic regulators.

Preferably, the device according to the invention is operated in such a way that a measuring gas is introduced into the device through the inlet means, and flows through the compressed powder sample, before it leaves the device again through the outlet means.

In order to ensure the provision of a unitary sample, in a preferred embodiment, the device according to the invention further has an automated pressing means for preparing the compressed powder sample.

In order to achieve a finer adjustment of the pressure and volume flow rate, the device according to the invention preferably has different regulators for the pressure and/or the volume flow rate of the measuring gas. Different measuring ranges can be covered by using the different regulators.

In a preferred embodiment, the device according to the invention further has several measuring stations connected in parallel, a central controlling and evaluation unit, and a central process computer for administering the measuring stations. In this way, the efficiency of the measuring device can be increased. In addition, the simultaneous measuring of samples in parallel measuring stations enables measuring staff to be employed economically. Depending on the requirements placed on the powders to be measured, the measuring range of the operating measuring stations can be varied. Preferably, the device according to the invention covers a range of grain sizes of from 0.2 to 200 μm, preferably from 0.2 to 100 μm. Because of the variation of the volume flow rate as a function of time according to the invention, it is further possible to provide sufficiently high amounts of gas to also measure powders that result only in a low pressure loss because of their coarse particles.

The present invention can further relate to the following items:

Item 1: A process for determining the equivalent diameter D of powder particles, characterized in that said equivalent diameter is determined by multi-point measurement.

Item 2: The process according to item 1, characterized in that said process comprises the following steps:
i) providing a powder sample in the form of a powder pellet;
ii) determining the porosity of the powder pellet based on the mass and height of the powder pellet;
iii) establishing the ratio of Δp and Q by allowing a measuring fluid to flow through the powder pellet by varying Δp or Q over time to obtain a characteristic, wherein Δp represents the difference between the pressure pᵤₚ upstream of the powder pellet and the pressure p_{down} downstream of the powder pellet, occurring in the direction of flow;
wherein Q designates the volume flow rate of the measuring fluid; and
iv) establishing the equivalent diameter D by derivation from the characteristic, taking the porosity of the powder pellet established in ii) into account.

Item 3: The process according to at least one of the preceding items, characterized in that at least two different measuring points are obtained in step iii) and/or iv) that do not correspond to the zero point (Δp=0; and Q=0) of the characteristic.

Item 4: The process according to at least one of the preceding items, characterized in that the characteristic of the relationship between Δp and Q is established by selectively varying the volume flow rate Q(t), or by selectively varying the pressure pᵤₚ(t).

Item 5: The process according to at least one of items 1 to 3, characterized in that the characteristic of the relationship between Δp and Q is established as a time course of the pressure pᵤₚ(t) upstream of the powder pellet.

Item 6: The process according to at least one of the preceding items, characterized in that the characteristic of the relationship between Δp and Q is obtained as a time course of the pressure pᵤₚ(t) upstream of the powder pellet when the volume flow rate Q(t) is continuously increasing.

Item 7: The process according to at least one of the preceding items, characterized in that said powder pellet is obtained by pressing a powder sample to be measured by using a defined force.

Item 8: The process according to item 7, characterized in that said pressing is effected in an automated way.

Item 9: A device for determining the equivalent diameter D of a powder sample by a process according to at least one of the preceding items, characterized in that said device includes a receiving means for receiving a sample tube with the powder pellet to be measured, a data acquisition means for acquiring the data pᵤₚ and p_{down}, or Δp, and Q, a data processing unit, a data output means, a pressure control means, an inlet means and an outlet means for a fluid, and a controller for feedback controlling the volume flow rate of the measuring gas.

Item 10: The device according to item 9, characterized in that said device further includes an automated pressing means for preparing a powder pellet.

Item 11: The device according to at least one of items 9 and 10, characterized in that said device further has several regulators for the pressure and volume flow rate.

Item 12: The device according to at least one of items 9 to 11, characterized in that the device has several measuring stations connected in parallel, and a central controlling and evaluation unit for administering the measuring stations.

### DESCRIPTION OF FIGURES

The advantages of the present invention are illustrated by means of the following Figures, which should not be understood as limiting the idea of the invention, however.

FIGS. 1a and 1b show the influence of the setup time, i.e., the time needed for the system to transition into a stationary, linearly increasing state, from the measuring of a WC powder having a grain size of 0.8 μm. The setup time was established to be 8 minutes in this case, so that a measuring time of 80 minutes would result for a conventional one-point measurement with 10 measured values. The influence of too short a setup time on the measurement can be seen clearly in the different deviations of the ratio of Q(t) versus Δp(t). The boxed area in FIG. 1a is shown in FIG. 1b, magnified. FIG. 1b shows the errors that result from an insufficient setup time in a conventional one-point measurement. FIG. 1B shows the segment marked in FIG. 1A and corresponding measured values of a one-point-measurement that corresponds to a measuring range of the classical FSSS method. As can be seen from the Figure, the classical one-point-measurement gives significantly deviating results even for sufficient setup times (graphs 1 and 2). In contrast, the process according to the invention allows for a significantly more precise measurement even for a shortened measuring time because of the multi-point measurement (graph 3). In this kind of measurement, a relative error of 7% was established. For the measuring points of the one-point-measurement, a deviation of up to 35% was observed.

FIG. 2 shows the characteristic of a multi-point measurement. Here, the relative error can be reduced to 1.5% by a suitable selection of the segment of the characteristic used to establish the equivalent diameter. Further, the measuring time could be reduced to 8 minutes by the multi-point measurement by creating the p (t) curve. The process according to the invention enables the entire characteristic to be used including the curved region, so that the selection of a suitable segment of the characteristic is dispensable, and also, it is no longer necessary to wait until the system has reaches a steady state. The measuring time can be reduced even further thereby. In addition, there are measuring situations in which the curve describes a weak, but significant curvature. In such a case, it takes very long until a linear course develops, which in turn is a disadvantage in view of a reduced measuring time.

FIGS. 3a, 3b, 4a and 4b respectively show a comparison of the measuring scatters in the form of Gaussian distribution curves between the conventional FSSS method and the process according to the invention.

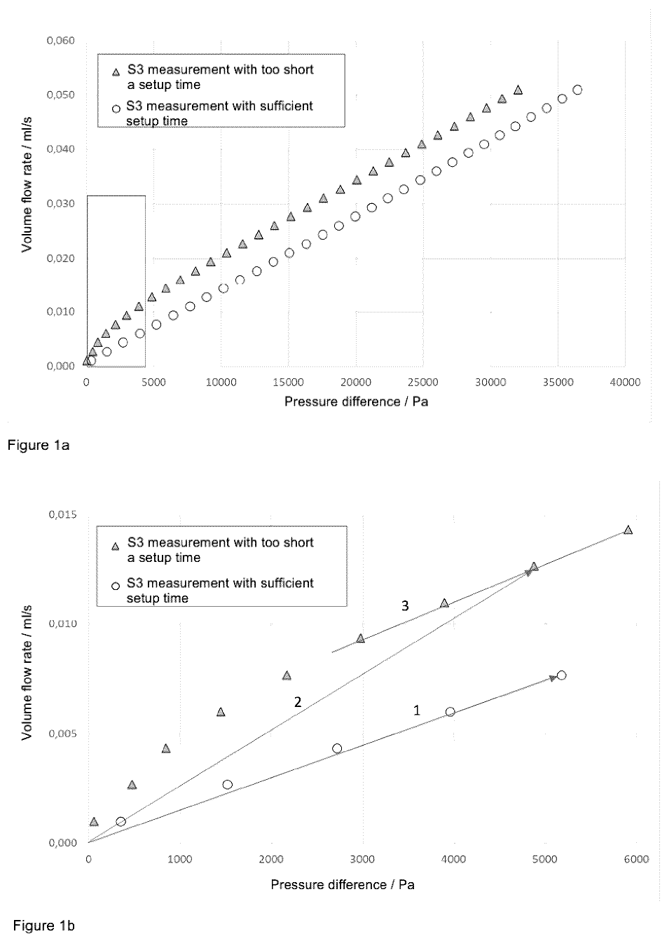

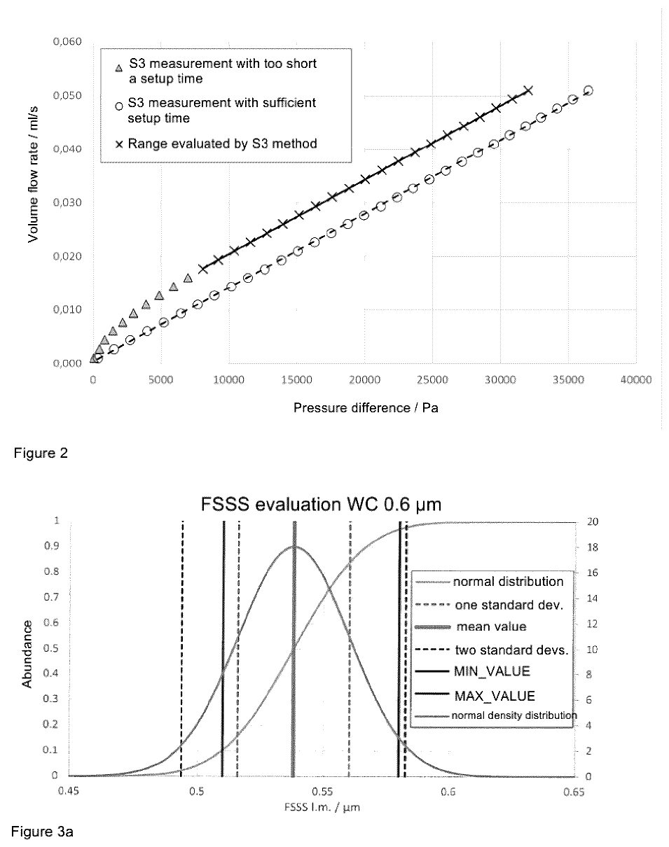

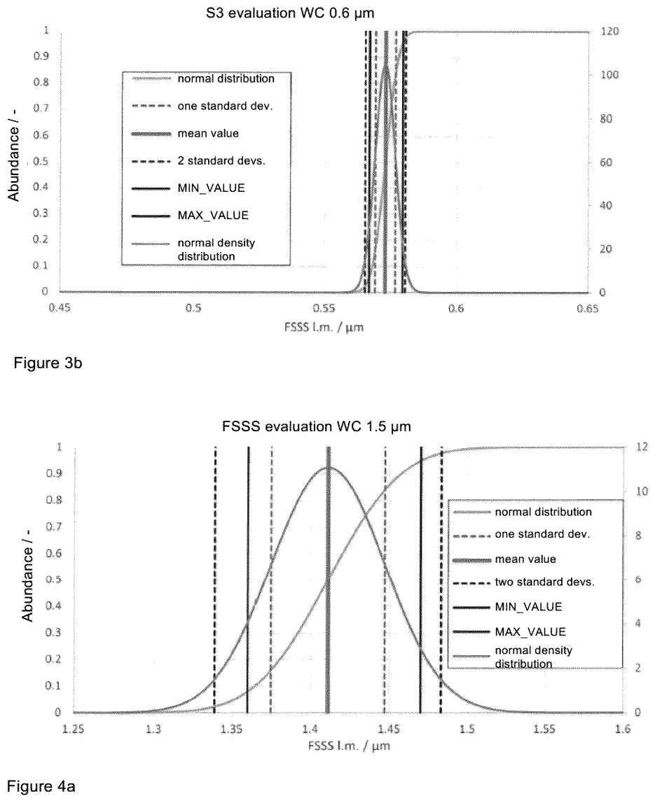

In order to check the precision, a sample having a known grain size was measured several times with a statistically significant number of measurements by the FSSS method and by the process according to the invention. In a first measurement, tungsten carbide powder having a grain size of 0.6 μm was selected. The comparison of the two methods shows a clearly broader scatter of the measured values in the determination according to the FSSS method (FIG. 3a), which employs devices that operate with a constant upstream pressure. Thus, only the pressure loss for a volume flow can be measured with these devices in the prior art. In contrast, the measurement of the same powder lot by the process according to the invention yielded a significantly narrower distribution of the measured values (FIG. 3b), which provides evidence of the higher precision of the process according to the invention.

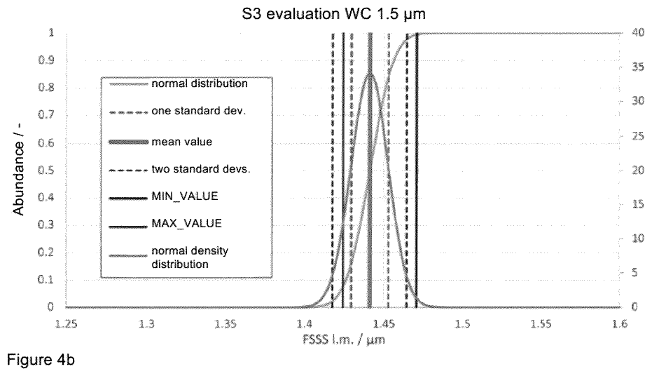

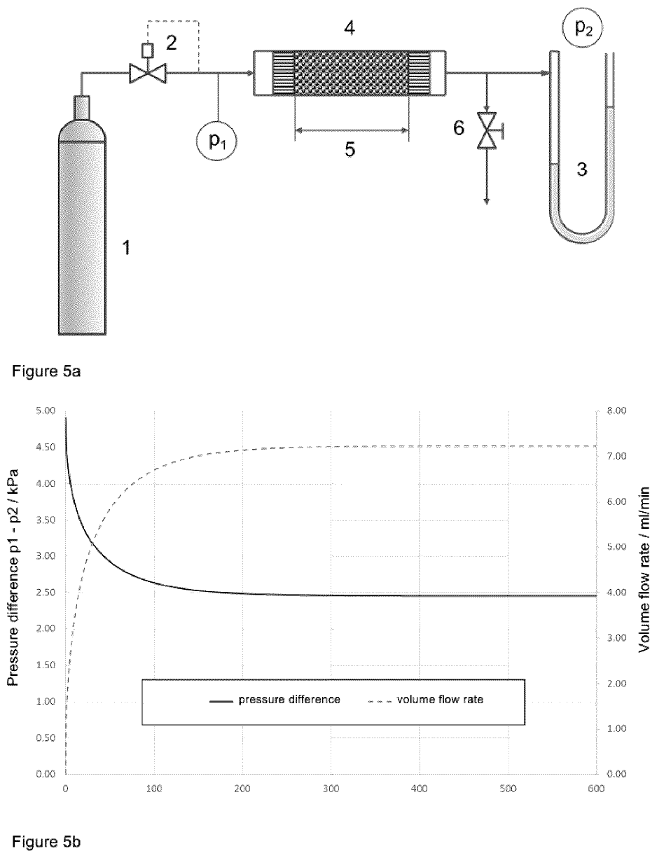

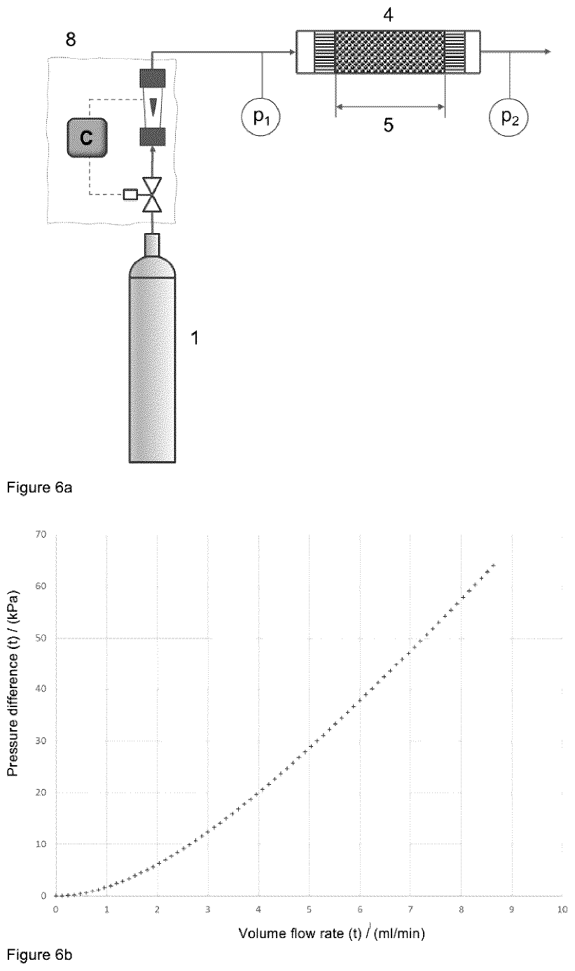

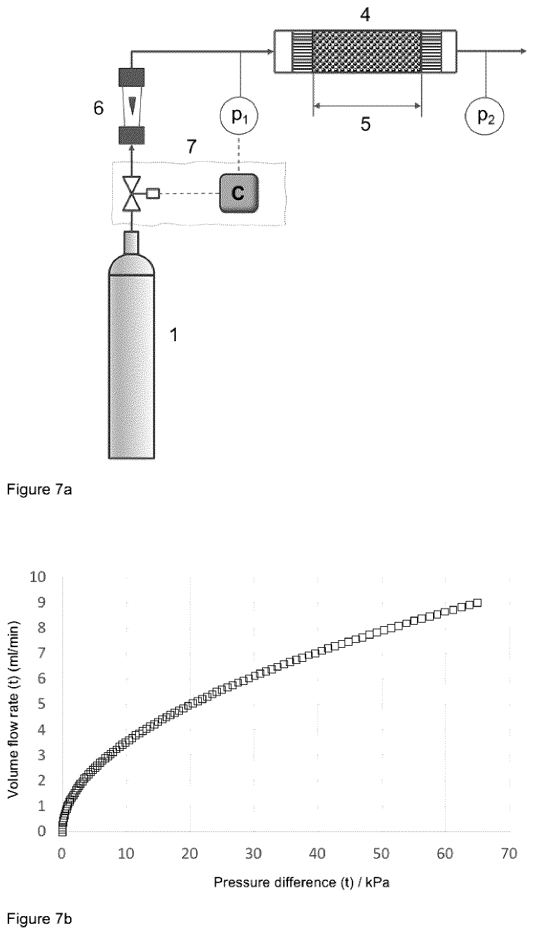

The same was observed when a tungsten carbide powder having a grain size of 1.50 μm was measured. Here too, measuring the sample by the FSSS method yields a significant scatter of the measured values (FIG. 4a), while a narrower distribution of the measured values could be achieved with the process according to the invention (FIG. 4b).

FIG. 5a schematically shows a conventional measuring set-up as used in the prior art, for example, in a Fisher Sub Sieve Sizer for the determination of particle size according to the FSSS method. A gas reservoir (1) supplies a measuring gas to the set-up. A constant upstream pressure p₁ (pᵤₚ) is applied to the sample through a constant pressure regulator (2). The measuring gas flows through the compressed powder sample (5) in a holder (4), which results in an increase of the pressure p₂ downstream of the sample (p_{down}). This pressure p₂ is indicated by a well-type manometer (3). The combination of the valve (6) and the well-type manometer (3) is equivalent to a volume flow rate measuring device. Using the valve (6), the system can be preset in such a way that a grain size can be read from an analogue indicator panel. The use of the well-type manometer (3) has the drawback that the gas volume downstream of the sample slowly increases, and additional gas has to flow through the sample to counterbalance this effect. This delays the setup of the measured value. Therefore, in order that a value can be determined with the system, one has to wait until all values have become stationary.

FIG. 5b shows a typical time course of the measured values pressure difference and volume flow rate that are relevant to grain size determination, as obtained in conventional measuring methods. After some time, the system adopts a steady state, and the values become constant. When this state has been reached, the values can be read and used for evaluation using the quotient ΔQ/p of the Carman-Kozeny equation. As can be seen from the graphs, robust results can be obtained only from a measuring time of about 300 s.

FIG. 6a schematically shows the realization of the process according to the invention in the embodiment of a constantly rising volume flow rate Q(t). A gas reservoir (1) supplies a measuring gas to the set-up. A constantly rising volume flow rate of the measuring gas is set by means of a volume flow controller (8). The measuring gas flows through the compressed powder sample (5) in a holder (4), Two electronic pressure gauges simultaneously determine the pressure p₁ of the measuring gas before it flows through the sample (5) (=pᵤₚ) and the pressure p₂ (=p_{down}) of the measuring gas after it has flowed through the sample (5). Thus, the time-dependent pressure difference Δp(t)=(p₁(t)−p₂(t)) versus the volume flow rate Q(t) that changes with time can be established using this set-up. From the established values for Δp(t) and Q(t), the non-linear characteristic Q(t) versus Δp(t) can be derived for determining the equivalent diameter.

FIG. 6B shows the change in time of the pressure and volume flow rate by the process according to the invention. Since the volume flow rate Q(t) increases constantly with time, the volume flow rate Q(t) can be used directly as the abscissa instead of time (t). Then, the determination of the equivalent diameter is effected using the whole characteristic Q(t) versus Δp(t). Thus, the process according to the invention offers the advantage that one does not have to wait until a steady state is obtained in the system.

FIG. 7a schematically shows the realization of the process according to the invention in the embodiment of a constantly rising pressure. A gas reservoir (1) supplies a measuring gas to the set-up. A constantly rising pressure is forced upon the system by using the controlling unit (7). Simultaneously, the volume flow rate of the measuring gas is measured by using the flow meter (6) as a system response, and the pressure p₂ was measured after the gas has flowed through the compressed powder sample (5) in a holder (4) (p_{down}). All characteristic values are recorded as time-dependent quantities.

FIG. 7b shows the change of the volume flow rate and of the pressure difference in their time dependence when using the process according to the invention. Then, the determination of the equivalent diameter is effected using the whole non-linear characteristic Q(t) versus Δp(t). Thus, the process according to the invention offers the advantage that one does not have to wait until a steady state is obtained in the system.

1. A process for determining the equivalent diameter D of powder particles, characterized in that said equivalent diameter is determined by recording a non-linear characteristic from Q(t) versus Δp(t), in which Q(t) refers to the volume flow rate as a function of time, and Δp(t) refers to the pressure difference as a function of time.

2. The process according to claim 1, characterized in that the characteristic describes a non-linear relationship between the pressure difference Δp(t) and the volume flow rate Q(t),
in which Δp(t) designates the time-dependent difference, occurring in the direction of flow, of a measuring gas when flowing through a compressed powder sample,
in which Q(t) designates the volume flow rate, which increases constantly over time, of the measuring gas, in which:
dQ(t)/dt=q₀, with q₀=constant, and q₀>0, where q₀ designates the volume flow change rate.

3. The process according to claim 1, characterized in that the characteristic describes a non-linear relationship between the pressure difference Δp(t) and the volume flow rate Q(t),
in which Δp(t) designates the pressure difference occurring in the direction of flow and changing over time with a constant change rate, between the pressure pᵤₚ upstream of the compressed powder sample, and the pressure p_{down} downstream of the compressed powder sample, wherein
dΔp(t)/dt=p₀, with p₀=constant and p₀>0;
wherein Q(t) designates the time-dependent volume flow rate of a measuring gas, and p₀ designates the pressure change rate.

4. The method according to claim 1, characterized in that said process comprises the following steps:
i) providing a compressed powder specimen;
ii) determining the porosity of the compressed powder specimen based on the mass and height of the compressed powder specimen;
iii) establishing the conductance L_{R} by allowing a measuring gas to flow through the compressed powder specimen and continuously varying Δp as a function of time Δp(t), or Q as a function of time Q(t), to obtain a non-linear characteristic, in which Δp(t) designates the time-dependent pressure difference occurring in the direction of flow between the pressure pᵤₚ upstream of the compressed powder sample, and the pressure p_{down} downstream of the compressed powder sample;
in which Q(t) designates the volume flow rate of the measuring gas, and L_{R}=Q/Δp; and
iv) establishing the equivalent diameter D by derivation from the non-linear characteristic Q(t) versus Δp(t), taking the porosity of the compressed powder sample established in ii) into account.

5. The process according to claim 1, characterized in that at least two different measuring points are obtained in step iii) and/or iv) that do not correspond to the zero point (Δp=0; and Q=0) of the characteristic.

6. The process according to claim 1, characterized in that at least 5 measuring points are established per minute.

7. The process according to claim 1, characterized in that the non-linear characteristic of the relationship between Δp(t) and Q(t) is established by selectively varying the volume flow rate Q(t), or by selectively varying the pressure pᵤₚ(t).

8. The process according to claim 1, characterized in that the non-linear characteristic Q(t) versus Δp(t) of the relationship between Δp(t) and Q(t) is established as a time course of the pressure pᵤₚ(t) upstream of the powder pellet.

9. The process according to claim 8, characterized in that said process comprises the following steps:
i) providing a compressed powder sample;
ii) determining the porosity of the compressed powder specimen based on the mass and height of the compressed powder specimen;
iii) setting a volume flow rate Q(t) of a measuring gas for flowing through the compressed powder sample in such a way that the pressure difference Δp(t) between the pressure pᵤₚ upstream of the compressed powder sample and the pressure p_{down} downstream of the compressed powder sample changes at a rate p₀ that is constant in time, wherein p₀=dΔp(t)/dt;
iv) establishing the conductance L_{R} from a non-linear characteristic Q(t) versus Δp(t),
iv) establishing the equivalent diameter D by derivation from the non-linear characteristic, taking the porosity of the compressed powder sample established in ii) into account.

10. The process according to claim 1, characterized in that the non-linear characteristic of the relationship between Δp(t) and Q(t) is obtained as a time course of the pressure pᵤₚ(t) upstream of the powder pellet as the volume flow rate Q(t) rises continuously.

11. The process according to claim 10, characterized in that said process comprises the following steps:
i) providing a compressed powder specimen;
ii) determining the porosity of the compressed powder specimen based on the mass and height of the compressed powder specimen;
iii) setting a constant volume flow change rate q₀ of a measuring gas for flowing through the compressed powder sample, wherein dQ(t)/dt=q₀ with q₀=constant;
iv) establishing the conductance L_{R} from a non-linear characteristic Q(t) versus Δp(t), in which Δp(t) is the pressure difference between the pressure pᵤₚ(t) upstream of the compressed powder sample and the pressure p_{down}(t) downstream of the compressed powder sample as a function of time,
iv) establishing the equivalent diameter D by derivation from the non-linear characteristic, taking the porosity of the compressed powder sample established in ii) into account.

12. The process according to claim 1, characterized in that the compressing of the powder sample is effected with a defined force.

13. The process according to claim 12, characterized in that said pressing is effected in an automated way.

14. A device for determining the equivalent diameter D of a powder sample by a process according to claim 1, characterized in that the device includes a receiving means for receiving a sample tube with a compressed powder sample to be measured, a data acquisition means for acquiring the data pᵤₚ(t) and p_{down}(t), or Δp(t), and Q(t), a data processing unit, a data output means, a process computer, a pressure control means, an inlet means and an outlet means for a gas, and a controller for feedback controlling the volume flow rate of the gas.

15. The device of claim 14, being characterized in that said device further includes an automated pressing means for preparing a compressed powder sample.

16. The device according to claim 14, characterized in that said device further has at least one regulator for the pressure and at least one regulator for the volume flow rate.

17. The device according to claim 14, characterized in that the device has several measuring stations connected in parallel, a central controlling and evaluation unit, and a central process computer for administering the measuring stations.

18. The process according to claim 6, characterized in that at least 12 measured points per minute.
